(19) United States
(12) Patent Application Publication
(10) Pub. No.: US 2011/0043535 A1
(43) Pub. Date: Feb. 24, 2011

(54) COLORIZATION OF BITMAPS

(75) Inventors: Paul J. Kwiatkowski, Redmond, WA (US); Ramkumar Subramanian, Redmond, WA (US); Robert A. Goins, Redmond, WA (US); Jeremy S. Knudsen, Monroe, WA (US); Lincoln K. Uyeda, Seattle, WA (US); Gary S. Henderson, Redmond, WA (US); Peter S. Ponomarev, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/543,064

(22) Filed: Aug. 18, 2009

(51) Int. Cl. G09G 5/02

(52) U.S. Cl. 345/604

(57) ABSTRACT

A bitmap may be transformed from one color scheme to another. In one example, the bitmap is used as part of a user interface (UI), and the colorization is performed to reflect a user's (or some other entity's) choice of color scheme. To perform the colorization, a bitmap may be converted from the red-green-blue (RGB) color space to the hue-saturation-lightness (HSL) color space. The hue may then be rotated toward the selected color scheme. Lightness and alpha (opacity) may be gamma-adjusted toward the selected color scheme. Saturation may be linearly adjusted upward or downward in the direction of the selected color scheme. The transformed HSL representation of the image may then be converted from the HSL space back to the RGB space. The new RGB bitmap may then be used to render one or more UI elements.

### BACKGROUND

Modern software typically has a user interface (UI) that is designed to be functional and eye-pleasing. Much thought goes into designing various aspects of the interface, such as the specific objects to be shown (e.g., buttons, tabs, sliders, etc.), the colors and contrast to be used, visual effects such as making some parts of the UI appear shiny and other parts matte, or other aspects of the UI.

Once the UI has been designed, there are various ways that the program can display the various elements of the UI. In one example, the UI elements are rendered by the program in real-time based on descriptions of the elements' underlying geometry. However, it may be more efficient (both in terms of runtime processor cycles, and in terms of the interface development process) to pre-calculate and store bitmaps of the UI elements.

A problem with a bitmap is that it is inflexible, in the sense that the bitmap represents a fixed image. One aspect of this inflexibility is that colors are fixed as part of the bitmap—i.e., if a particular UI element is drawn by its designer in red, then the red hue of the UI element inheres in the numeric representation of the pixels in the bitmap. Many software applications are designed to offer the user a choice of color schemes. In theory, it is possible to analyze a bitmap and change the colors in the bitmap. However, changing the color scheme of a bitmap typically leads to visual artifacts, or otherwise creates disagreeable results.

### SUMMARY

Bitmaps may be re-colorized by performing various transformations on the colors in the bitmaps, which allows the bitmap to be colorized in a user's (or other entity's) chosen color scheme. In one example, the transformation may be performed using the following techniques. A bitmap that is represented in the red-green-blue (RGB) color space may be converted to the hue-saturation-lightness (HSL) color space. In the HSL space, the following transformations may be performed: The hue of pixels in the bitmap may be rotated based on the user's color choice. The lightness of the pixels may be adjusted toward the user's color choice using a gamma function. The gamma function may also be applied to the alpha value (opacity) of the pixels. And the saturation of the pixels may be linearly adjusted toward a saturation of zero (completely unsaturated) or one (fully saturated) depending on whether the user's chosen color scheme is less saturated or more saturated than the original color scheme of the bitmap. After one or more of these transformations have been performed, the resulting bitmap may be converted from the HSL space back to the RGB space. The new RGB bitmap represents the same visual elements as the original bitmap, but with the user's choice of color scheme applied.

One aspect of preserving high-quality images across the re-colorization transformations is to use different transformation functions for different parts of the bitmap. For example, different transformation functions could be used for the background and highlight portions of a UI. For example, the exponent used for the gamma function, and the coefficient used for the linear transformation, could have one set of values for background pixels in the UI, and could have a different set of values for the highlight pixels in the UI. A bitmap could be designed in such a way as to indicate which portions of the UI are background and which are highlight—e.g., the UI designer could be told to use opposite colors on the color wheel, such as blue and orange, to represent the background and highlight portions respectively. It may be the case that certain aspects of a UI (e.g., the level of “shine” in certain highlights) transform more realistically under one set of functions than under a different set of functions. Thus, the use of different functions for different portions of the UI may allow the color transformation to produce an overall high-quality UI image.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example bitmap colorization process.

FIG. 2 is a flow diagram of an example bitmap colorization process.

FIG. 3 is a block diagram of an example in which a component identifies a color that is representative of a bitmap.

FIG. 4 is a block diagram of an example in which different algorithms are chosen for different parts of a bitmap.

FIG. 5 is a block diagram of a colorizer, which may be used to implement some or all of the techniques described herein.

FIG. 6 is a block diagram of an example user interface with elements that may be customized through re-colorization.

FIG. 7 is a block diagram of example components that may be used in connection with implementations of the subject matter described herein.

### DETAILED DESCRIPTION

In modern software, user interfaces (UIs) are typically made up of images. Menus, icons, ribbons, controls, and other aspects of a UI are examples of UI elements that can be drawn on a screen to facilitate user interaction with a program. There are various ways to draw these elements. In one example, a model of the elements is created (e.g., by specifying text and geometric shapes that make up an image), and images are generated in real-time from the model. In another example, a bitmap of the images is stored, and the bitmap is displayed on the screen in the appropriate place. The bitmap may be pre-generated from a model, or may be created directly by an interface designer.

When a bitmap is used, one issue that arises is that a bitmap represents a fixed image that is difficult to modify. One aspect of this inflexibility is that a bitmap incorporates a specific color into its representation of each pixel. In theory, the colors in a bitmap can be changed. However, because of the way in which different colors are perceived by the human eye, and also because of other factors, naive transformation of a bitmap's colors often produces visual artifacts and other disagreeable features.

The subject matter described herein may be used to transform the color in a bitmap. The color transformation may be used to allow a user (or some other entity) to choose the color scheme for a UI, although the transformations described herein could be used in any appropriate context.

In order to apply a color to a bitmap, the target color scheme for the bitmap is chosen. The target color scheme may be expressed as a particular color that is representative of the overall appearance that the bitmap is to have after the color transformation occurs. (The “overall” appearance of a bitmap could be represented by its average color calculated over all pixels in the bitmap, or could be a color that is prevalent throughout the bitmap, or could be determined in some other manner.) The original bitmap, likewise, has a representative color (which could also be calculated as an average of all the pixels in the bitmap, or could be determined in some other manner). Thus, re-colorizing a bitmap is performed by modifying the pixels in the original bitmap in an amount that is based on the difference between the original bitmap's representative color and the target color.

The original bitmap is typically represented in the RGB color space. In order to perform the transformation, the RGB bitmap is converted into the HSL color space. (The RGB and HSL color spaces are generally known in the relevant fields.) After the original bitmap has been converted to the HSL color space, transformations are performed on the hue (H), saturation (S), and lightness (L) values, and also on the opacity value (typically referred to as the alpha value) value if present. In the HSL space, hue is modeled by placing colors in the visible light spectrum along the circumference of a circle, and thus transformation of hue is performed by rotating the color through some number of degrees. The original bitmap's representative color has a hue, and so does the color that represents the target color scheme. Thus, the angle between these hues is calculated, and the hues of individual pixels are transformed by rotating them through the calculated angle. E.g., if the original bitmap has a representative hue of 15° and the target color scheme is represented by a color whose hue is 90°, then the angular difference between these hues is 75°, so the hue in the original bitmap may be changed by rotating each pixel's hue by 75°. (In another example, hue could be transformed in some other way—e.g., the hue could simply be set to the hue of the target color.)

The saturation of each pixel may be changed by performing a linear transformation on each pixel (or by performing some other transformation based on a monotonic function). For example, if the original bitmap has a saturation of 0.4 and the color that represents the target color scheme has a saturation of 0.2, then the target color has half the saturation of the original bitmap, so pixels in the original bitmap with a saturation of 0.4 or less (i.e., pixels whose saturation is less than or equal to the representative saturation of the original bitmap) may be transformed by scaling each pixel by a factor of one-half (i.e., by multiplying each pixels' saturation by 0.5). On the other hand, if the pixel has a saturation greater than the original bitmap's representative saturation (less than 0.4), then adjustment of the pixel's saturation may be performed by scaling toward full saturation using the formula S′=1−X(1−S), where S′ is the transformed saturation of the pixel, and where X is equal to the ratio of <one minus the target saturation> to <one minus the original bitmap's representative saturation>—i.e., X=(1−0.2)/(1−0.4)=4/3. In the foregoing example, the target is closer to zero saturation than the original bitmap so scaling is performed in the direction of zero saturation. However, if the target scheme's representative color had a higher saturation that the original bitmap's representative color, then the scaling could be performed toward full saturation. For example, if the original bitmap's saturation is 0.4 and the target saturation is 0.8, then the target is one-third as far from full saturation as the original bitmap. (I.e., 0.8 is 0.2 away from a full saturation of 1.0, while 0.4 is 0.6 away from a full saturation of 1.0. Thus, 0.2 is one-third as far away from full saturation as 0.6). In this case, for pixels whose saturation is greater than or equal to the original bitmap's representative saturation, the transformed saturation of the pixel, S′, may be given by the formula S′=1−⅓(1−S). On the other hand, if the pixel's saturation is less than the representative saturation of the original bitmap, then the transformed saturation, S′, may be given by the formula S′=XS, where X is equal to the ratio of <the original bitmap's saturation> to <the target saturation>, or X=0.4/0.8=½.

The lightness of a pixel may be modified by gamma correction. In particular, a pixel in the original bitmap may be adjusted toward the target color by raising the pixel's lightness value to some exponent. If an opacity (alpha) value is present, then the alpha value of a pixel also may be adjusted by gamma correction.

After some or all of the above transformations have been applied to the HSL representation of the bitmap, the transformed HSL representation may be converted back to the RGB space. The new RGB bitmap may then be used, for example, as part of a UI.

Different parts of a bitmap (or different bitmaps that are part of an application's UI) may be transformed in different ways. For example, particular pixels within a UI bitmap may act as the “background” of the UI, or as the “highlight” of the UI (or may play some other role within the UI). The designer of a UI may identify the different portions using different colors (or by some other mechanism). For example, opposing colors on the color wheel (e.g., blue and orange) could be used to identify the background pixels and highlight pixels, respectively. Thus, the conversion process could use different algorithms to change the colors of different sets pixels (e.g., different gamma functions for adjusting lightness and opacity, or different coefficients for performing linear adjustment on saturation). Particular algorithms could also be chosen based on the nature of the image in the bitmap that is being re-colorized—e.g., re-colorization of pixels that make up a glossy part of an image might be re-colorized with a different algorithm than pixels that make up a matte part of the image. Since the user's visual perception and/or expectations may differ for different portions of a UI, using different functions for different parts of the UI may increase the perception of quality, and may decrease the perception of distortion, when UI images are re-colorized.

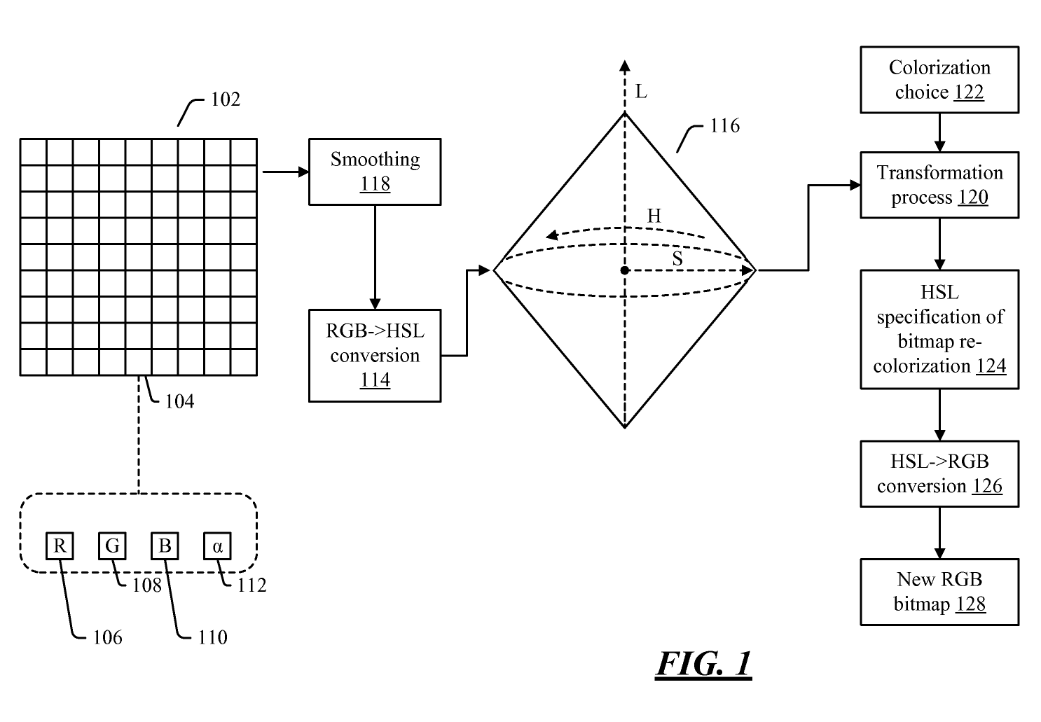

Turning now to the drawings, FIG. 1 shows an example process of re-colorizing a bitmap. Bitmap 102 is an RGB representation of an image. Bitmap 102 comprises a plurality of pixels arranged in two dimensions. Each pixel 104 may have various components. In the RGB color space, the color and luminosity of each pixel is represented by the combination of specific red, green, and blue values. Thus, pixel 104 may have a red component 106, a green component 108, and a blue component 110. If pixel 104 has a variable opacity, then pixel 104 may also have an opacity (a) component 112.

In order to re-colorize bitmap 102, the bitmap may undergo a smoothing process 118. Smoothing process 118 attempts to preserve true contrast in the bitmap, while minimizing the exaggeration of false or insignificant contrast. For example, consider a vertical line of pixels whose red values are: 141, 141, 142, 142, 198, 199, 199, 198, 198, 198. (The red channel is used here as an example, although the smoothing process described herein could be used for any type of channel. Moreover, a vertical line of pixels is used as an example, although the process described herein could be used to smooth a line of pixels in any direction.) The issue that arises in the pixel values listed above is that there is a hard boundary (represented by the significant difference in value between 142 and 198), but—on opposite sides of that boundary—the variations in value that exist are either small or accidental. For example, the variations between 141 and 142 may represent a very small intensity ramp that was intentionally introduced by the image designer, or may represent a rounding error introduced by the designer's image-editing software. On the other side of the hard boundary, the way that the values meander between 198 and 199 strongly suggests a rounding error rather than intentional variations. Since the eye perceives variations in color differently depending on where the color appears on the spectrum, re-colorization of the bitmap could have the effect of exaggerating the visual appearances of these small differences in value. The smoothing process reduces this exaggeration.

In order to smooth a set of pixel values such as the above example list of values in the red channel, the process first converts integer values to floating point values—e.g., 141 is converted to 141.0, and so on. Then the process attempts to detect hard boundaries in the line. (Hard boundaries are detected to determine which sets of pixels are to be smoothed; in one example, smoothing is performed among the pixels on either side of a hard boundary, but smoothing of pixels that cross a hard boundary may be avoided.) There are various ways to detect a hard boundary, but one example way is to look for adjacent pixels whose values differ by more than one. When adjacent pixels differ in value by more than one, it is possible to assume that the difference is an intentional part of the visual design, rather than a rounding error introduced by the design software. Thus, the boundary detection algorithm might assume that differences in adjacent pixels of more than one represent a real boundary, while differences of one or less indicate that the pixels are part of a group that is subject to smoothing. It is possible to group together adjacent pixels whose values differ by more than one, but there is a trade-off between noise reduction and blurring, and the smoothing algorithm may choose an appropriate cutoff in order to take this tradeoff into account.

Applying the above principles to the above list of example values, two groups of pixels to be smoothed would be detected: 141.0, 141.0, 142.0, and 142.0 would be one group, and 198.0, 199.0, 199.0, 198.0, 198.0, and 198.0 would be the other group. Since the first group starts with 141.0 and goes up to 142.0, this increase is smoothed over all four values, so that the four values are adjusted to 141.00, 141.33, 141.67, and 142.00. The second group of number is more like an arc that starts and ends at 198.0, but goes up to 199.0 in the middle. This sequence of number could thus be smoothed to 198.00, 198.67, 198.67, 198.33, 198.00, and 198.00.

After smoothing has been performed, an RGB→HSL conversion 114 may be performed in order to convert bitmap 102 from the RGB space into the HSL space 116. There are various known algorithms that may be used to convert between RGB space and HSL space. As is generally known, the HSL space is a model in which a pixel's appearance is represented by the properties of hue, saturation, and lightness. The HSL model is normally represented as a double cone, as shown in FIG. 1. The HSL model incorporates the concept of a color wheel to describe the range of visible light wavelengths, and thus the hue (H) of a pixel is represented by the angular position of a specific color around a circular cross section of the double cone. The lightness (L) of a pixel is the amount of luminosity in that pixel, which is represented by the position along the L axis (with higher position representing a higher luminosity). The saturation (S) of a pixel is represented is represented by distance from the center of a circular cross section. The meanings of hue, saturation, and lightness are generally known in the fields of computer graphics and imaging.

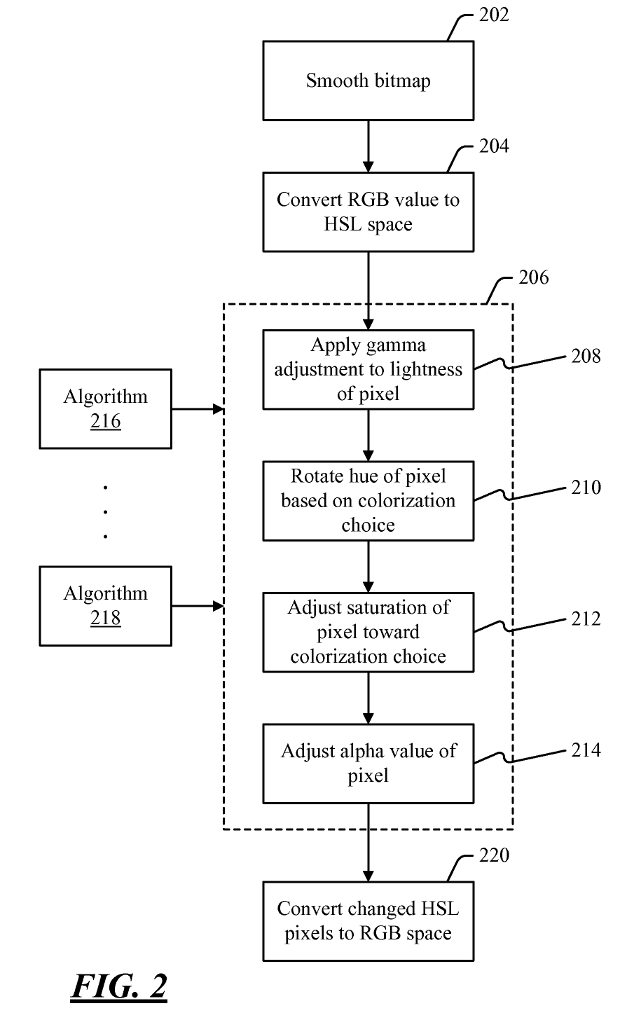

When the bitmap has been converted to the HSL color space, the re-colorization transformation process 120 may be performed. Transformation process 120 receives, as input, a colorization choice 122. This choice may have been specified by a user (e.g., the user interface could present the user with controls that allow the user to make a color choice). Or, colorization choice 122 could be made by some other entity such as an administrator, a software designer, etc. Colorization choice 122 may be expressed as a specific color in the HSL space—that is, the color may be expressed as a hue, a saturation, and a lightness. The expression of the color choice in this manner provides a reference point in the HSL color space toward which the colors in the bitmap may be adjusted. As noted above, a given bitmap's representative color may be determined (e.g., by averaging all of the colors in the bitmap), and the re-colorization process may adjust the various component of the color based on the direction and amount by which colorization choice 122 differs from the representative color of the original bitmap. For example, if colorization choice 122 has a hue that is 60 degrees counterclockwise from the original bitmap's representative hue, then re-colorization of the bitmap may be performed by rotating each of the original pixels' hues counterclockwise by 60 degrees. Or, if the saturation of colorization choice 122 is lower (or higher) than the representative saturation of the original bitmap, then the saturation of each pixel could be adjusted downward (or upward) accordingly. Examples of how to perform particular aspects of transformation process 120 are discussed below in connection with FIG. 2.

Once transformation process 120 has been performed, the result is an HSL specification 124 of the re-colorized bitmap. This HSL specification then may undergo an HSL→RGB conversion 126 in order to change the re-colorized bitmap back to the RGB space. As noted above, algorithms for converting between HSL and RGB are generally known. HSL→RGB conversion 126 produces a new RGB bitmap 128. Bitmap 128 may then be used as part of the UI, and reflects the re-colorization of the original bitmap based on colorization choice 122.

FIG. 2 shows an example process of re-colorizing a bitmap. Before turning to a description of FIG. 2, it is noted that the flow diagram of FIG. 2 shows an example in which stages of a process are carried out in a particular order, as indicated by the lines connecting the blocks, but the various stages shown in this diagram can be performed in any order, or in any combination or sub-combination.

At 202, the original bitmap may be smoothed. An example of a smoothing process is described above. As noted above, the smoothing may take place with respect to lines in one direction (e.g., the vertical direction). In one example, a sufficient smoothing effect is achieved by smoothing lines only in the vertical direction, although smoothing could be performed in any direction or in any combination of directions.

At 204, the RGB values in the original bitmap may be converted to the HSL color space. Certain types of transformations are easier to perform in the HSL space than in the RGB space (although the subject matter herein applies to colorization of images that are represented in any manner).

Colorization process 206 may then be performed on a bitmap (e.g., on the HSL bitmap that resulted from the conversion that was performed at 204). The colorization process may adjust the hue, saturation, lightness, and opacity of the bitmap, by performing the actions shown at 208, 210, 212, and 214. These actions are now described. It is noted that the actions at 208-214 are shown in a particular order, although these actions could be performed in any order, or in any combination or sub-combination.

At 208, a gamma adjustment is performed on the lightness (L) component of each pixel. Gamma adjustments are generally known in the field of image processing; in general, a gamma adjustment is performed by applying a function that raises a value to a particular exponent. The actual exponent that is chosen is determined by the algorithm that applies to the pixel. As noted above, different algorithms could be used to colorize different parts of a bitmap. FIG. 2 shows example algorithms 216 and 218, although any number of algorithms could be used. (Algorithms 216 and 218 could affect any aspect(s) of colorization process 206, as indicated by the arrows leading from those algorithms to colorization process 206.) As noted above, different algorithms could be used for the background and highlight portions of a UI. Or, as another example, different algorithms could be used for the matte and shiny portions of a UI. Each algorithm could specify a different exponent to be used in the gamma adjustment. In one example, gamma could be determined by a formula such as γ=log L_{AvgMin}/log L_{Avg}, where L_{AvgMin} is a target minimum average luminosity for a transformed bitmap, and L_{Avg} is the average luminosity of the bitmap to be transformed.

At 210, the hue of a pixel is rotated based on the colorization choice that is being applied to the bitmap. For example, as described above, if the colorization choice is expressed by a color whose hue is 60 degrees counterclockwise of the original bitmap's overall color, then each pixel may be transformed by rotating its color 60 degrees counterclockwise.

At 212, the saturation of each pixel may be adjusted toward the colorization choice. Saturation is expressed on a scale of 0.0 (no saturation) to 1.0 (full saturation). One way to perform saturation adjustment is linearly—i.e., to use a constant factor to scale the pixel's original saturation toward no saturation or toward full saturation. The question of whether to scale toward no saturation or toward full saturation may be resolved by determining whether the target colorization choice has a higher or lower saturation than the representative color of the original bitmap. For example, if the original bitmap has a saturation of 0.4 and the color that represents the target color scheme has a saturation of 0.2, then the scaling may be performed in the downward direction—i.e., toward a saturation of 0.0. As described above, different formulas could be used to scale a pixel's saturation downward or upward, depending on whether the original bitmap's representative saturation is higher or lower than the saturation of the colorization target.

If an opacity (alpha) value is present, then the alpha value may be adjusted (at 214) using the gamma adjustment that was applied at 208. The gamma adjustment for each pixel may be performed using the same exponent that is used to adjust lightness in that pixel. One example of adjusting the alpha value of a pixel is as follows. A given bitmap may represent the highlighting of some image that appears underneath it. (E.g., a white, or predominantly white, bitmap might be superimposed over a UI element when the user hovers the mouse over the UI; this white bitmap may be used to highlight the UI element that is being hovered over.) When the underlying UI element has relatively bright (high luminosity) background colors, the highlight bitmap may have an alpha of 100%. When the underlying UI element has a dark color, then the highlight bitmap may be made more translucent by lowering the alpha. This technique keeps the visual effect of the highlight proportional to the background underneath it—that is, there may be a dependency between the alpha of this the highlight bitmap and the background color.

At 220, the transformed HSL image may be converted to the RGB space in order to create a new bitmap. This new bitmap has been re-colorized relative to the original bitmap, by adjusting the color values of the pixels toward a target color. If the bitmap is part of a UI, then the newly-colored RGB bitmap may be used to display the UI.

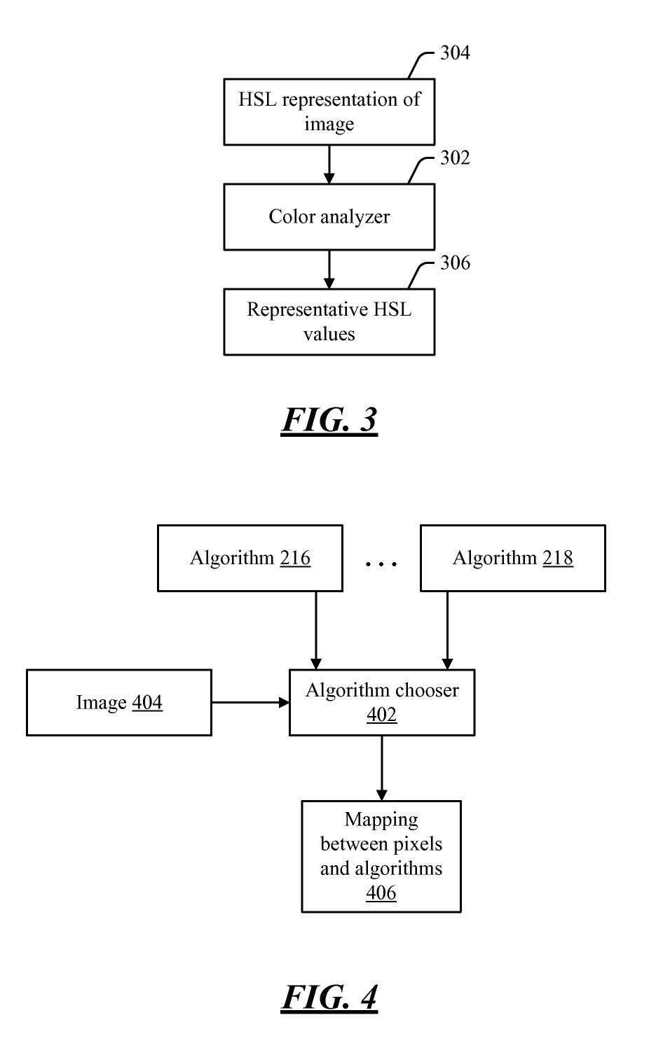

As noted above, the process of changing the color of a bitmap toward a target color may involve a comparison between the target value and a color that is representative of the original bitmap. E.g., in order to determine how much to rotate the hue of the pixels in the original bitmap, a determination may be made of the angle between (a) the target color's hue and (b) the hue of a color that is representative of the original bitmap. Thus, the process of re-colorizing a bitmap may start with identifying a color that is representative of the original bitmap. FIG. 3 shows an example component that may be used to identify this representative color. In particular, color analyzer 302 receives an HSL representation of an image 304. For example, the HSL representation of an image may be the data that results after converting an RGB bitmap to the HSL color space (as described above in connection with FIG. 1). Color analyzer 302 may perform various operations in order to determine the representative color. For example, color analyzer 302 may calculate the average hue, saturation, and lightness values across all pixels, and the representative color may be the result of that averaging operation. Or, color analyzer 302 could attempt to identify the prevalent color values in the image (e.g., the hue, saturation, and lightness values that occur with the greatest frequency). Once color analyzer 302 has analyzed the input image, color analyzer 302 may produce representative hue, saturation, and lightness values 306. These values then define a color that is representative of the bitmap. The transformations described above may involve determining the difference between the original bitmap and the target color (e.g., as in the case where the angle between the original bitmap and the target color is calculated). For the purpose of such calculations, values 306 may be used to define the color that is representative of the original bitmap.

As noted above, different algorithms may be used to perform the color transformation on different sets of pixels in a bitmap. For example, background and highlight portions of a UI may be transformed using different algorithms. Or, the shiny and matte portions of a UI may be transformed using different algorithms. FIG. 4 shows an example in which different algorithms are chosen for different parts of a bitmap.

Algorithm chooser 402 is a component that determines which algorithm applies to a given pixel in a bitmap. In the example of FIG. 4, algorithm chooser 402 chooses between two algorithms 216 and 218, although algorithm chooser 402 could choose between any number of algorithms. Algorithm chooser receives an image 404 as input, and determines whether algorithm 216 or algorithm 218 applies to a given pixel in image 404 (e.g., based on where the given pixel is located in the bitmap). One way that algorithm chooser 402 could make this choice is based on the color of a given pixel. For example, the background and highlight portions of a UI could be assigned to opposite colors on a color wheel (e.g., blue and orange), and UI designers could be instructed, when designing the original version of the UI, to use colors near orange for the highlight and colors near blue for the background. Thus, algorithm chooser 402 could choose an algorithm based on whether the hue of a given pixel is closer to blue or orange. Or, as another example, a mask could be created that identifies different portions as having various different properties—e.g., background versus highlight, matte versus shiny, etc. Then algorithm chooser 402 could identify which algorithm applies to which pixels by reading the mask. (The mask, and the use of opposition colors on a color wheel, are example ways of providing an indication as to which algorithm applies to a given pixel.)

When algorithm chooser 402 has identified which algorithms apply to which pixels in image 404, a mapping 406 may be produced that identifies the correspondence between the pixels and the algorithms. Mapping 406 may be used as part of the re-colorization process, so that the re-colorization process can apply the appropriate algorithm to a given pixel—i.e., pixels in a bitmap could be divided into different sets, and the particular algorithm to be applied to a pixel could be determined based on which set the pixel falls into.

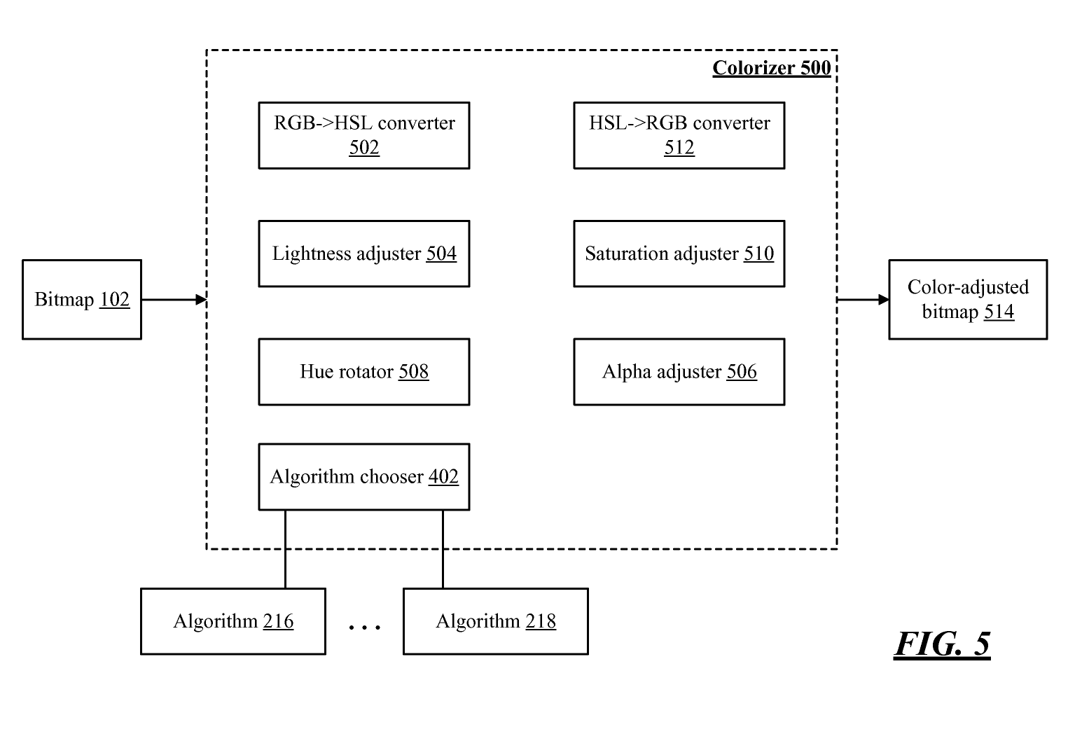

FIG. 5 shows an example of a colorizer 500, which may be used to implement some or all of the techniques described herein.

Colorizer 500 receives an original bitmap 102. Original bitmap 102 may contain an image that constitutes some or all of a UI, although bitmap 102 could contain any kind of image. Colorizer 500 may contain various components that perform processes described above. For example, colorizer 500 may contain an RGB→HSL converter 502 that converts a bitmap from the RGB color space into the HSL color space. Colorizer 500 may also contain a lightness adjuster 504, which adjusts the lightness of an image. As discussed above, lightness may be adjusted using a gamma function, and lightness adjuster 504 may implement this gamma function. Colorizer 500 may also contain an alpha adjuster 506, which adjusts the opacity of an image. As discussed above, opacity may be adjusted using the gamma function that is used to adjust lightness, so alpha adjuster 506 may implement the same gamma function as lightness adjuster 504 (or these two adjusters may be implemented by the same component).

Colorizer 500 may also contain a hue rotator 508. As discussed above, the hue of a bitmap may be changed by determining the angle on a color wheel between the original bitmap's representative hue and the target hue, and then rotating the hue of each pixel in the original bitmap by that angle. Hue rotator 508 may be used to perform this rotation.

Colorizer 500 may also contain a saturation adjuster 510. As discussed above, saturation may be adjusted linearly by scaling the amount of saturation in a pixel toward, or away from, either no saturation (0.0) or full saturation (1.0). Saturation adjuster 510 may be used to make these adjustments.

As discussed above, the colorization process may use different algorithms for different portions of a bitmap. Thus, colorizer 500 may include the algorithm chooser 402 that is described above in connection with FIG. 4, and that chooses between plural algorithms such as algorithms 216 and 218.

As described above, after the color transformations have been performed in the HSL color space, the transformed bitmap may be converted back to the RGB color space. Thus, colorizer 500 may contain an HSL→RGB converted 512 that performs this conversion.

Colorizer 500 may use the components described above to produce a color-adjusted bitmap 514. This color-adjusted bitmap 514 (which may be in the RGB color space) may be used to display an image—e.g., the visual elements of a UI.

FIG. 5 shows a colorizer 500 that contains an example set of components, although colorizer 500 could contain fewer components than shown, or could contain additional components. For example, as noted above, a smoothing process may be performed on a bitmap, so colorizer 500 could contain a smoothing component that performs the smoothing process described above.

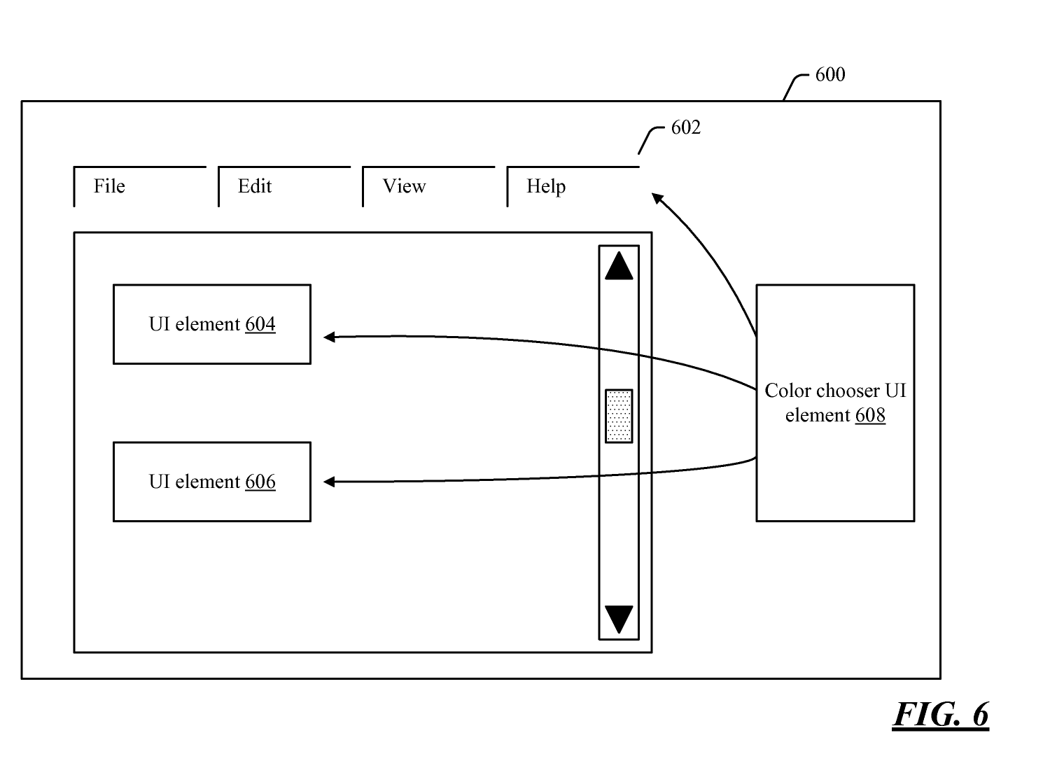

As noted above, colorization of bitmaps may be used to customize the appearance of a user interface (UI). FIG. 6 shows an example UI, with elements that may be customized through re-colorization.

User interface 600 is the interface for an application, such as a word processing program. User interface 600 may comprise various UI elements 602, 604, and 606. UI element 602 may be, for example, a menu bar or ribbon that a user uses to control the application. The menu bar or ribbon may have various visual features (e.g., particular colors or shades of color for a given tab, a visual gradient that moves across the screen from dark to light, etc.). Additionally, the menu bar or ribbon may display differently in response to user input. For example, when the user moves a pointing device over a portion of the menu or ribbon, that portion may appear highlighted—e.g., it may appear in a different color, or may appear to change from a matte appearance to a shiny appearance. UI elements 604 and 606 may be other visual features of user interface 600, such as particular images, particular controls, etc.

User interface 600 may include a color chooser UI element 608. For example, UI element 608 may include sliders, dials, a color disk, or any other element that allows a user to select a color for a UI. The selected color may be used as the target color for re-colorization of the UI bitmaps. As indicated by the arrows leading from UI element 608 to the other portions of user interface 600, the color selected through UI element 608 may affect the appearance of the other UI elements in user interface 600.

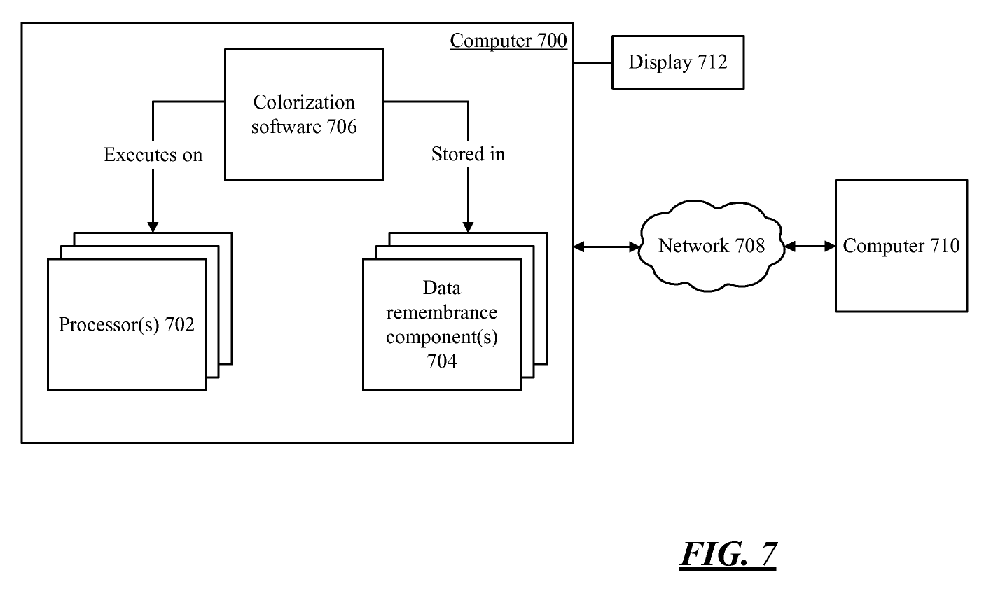

FIG. 7 shows an example environment in which aspects of the subject matter described herein may be deployed.

Computer 700 includes one or more processors 702 and one or more data remembrance components 704. Processor(s) 702 are typically microprocessors, such as those found in a personal desktop or laptop computer, a server, a handheld computer, or another kind of computing device. Data remembrance component(s) 704 are components that are capable of storing data for either the short or long term. Examples of data remembrance component(s) 704 include hard disks, removable disks (including optical and magnetic disks), volatile and non-volatile random-access memory (RAM), read-only memory (ROM), flash memory, magnetic tape, etc. Data remembrance component(s) are examples of computer-readable storage media. Computer 700 may comprise, or be associated with, display 712, which may be a cathode ray tube (CRT) monitor, a liquid crystal display (LCD) monitor, or any other type of monitor.

Software may be stored in the data remembrance component(s) 704, and may execute on the one or more processor(s) 702. An example of such software is colorization software 706, which may implement some or all of the functionality described above in connection with FIGS. 1-6, although any type of software could be used. Software 706 may be implemented, for example, through one or more components, which may be components in a distributed system, separate files, separate functions, separate objects, separate lines of code, etc. A computer (e.g., personal computer, server computer, handheld computer, etc.) in which a program is stored on hard disk, loaded into RAM, and executed on the computer's processor(s) typifies the scenario depicted in FIG. 7, although the subject matter described herein is not limited to this example.

The subject matter described herein can be implemented as software that is stored in one or more of the data remembrance component(s) 704 and that executes on one or more of the processor(s) 702. As another example, the subject matter can be implemented as instructions that are stored on one or more computer-readable storage media. Such instructions, when executed by a computer or other machine, may cause the computer or other machine to perform one or more acts of a method. The instructions to perform the acts could be stored on one medium, or could be spread out across plural media, so that the instructions might appear collectively on the one or more computer-readable storage media, regardless of whether all of the instructions happen to be on the same medium.

Additionally, any acts described herein (whether or not shown in a diagram) may be performed by a processor (e.g., one or more of processors 702) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, computer 700 may be communicatively connected to one or more other devices through network 708. Computer 710, which may be similar in structure to computer 700, is an example of a device that can be connected to computer 700, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. One or more computer-readable storage media that store executable instructions to colorize a first bitmap, wherein the executable instructions, when executed by a computer, cause the computer to perform acts comprising:
converting the first bitmap from red-green-blue (RGB) space to hue-saturation-lightness (HSL) space to create a first HSL bitmap;
receiving a colorization target;
using said colorization target to perform one or more transformations on said first HSL bitmap to generate a second HSL bitmap;
converting said second HSL bitmap to RGB space to produce a second bitmap; and
displaying said second bitmap to a user.

2. The one or more computer-readable storage media of claim 1, wherein said one or more transformations are performed using a first algorithm on a first set of pixels in said first HSL bitmap, and wherein said one or more transformations are performed using a second algorithm on a second set of pixels in said first HSL bitmap, said second set of pixels being different from said first set of pixels, said second algorithm being different from said first algorithm.

3. The one or more computer-readable storage media of claim 2, wherein said acts further comprise:
determining, based on which portion of said first HSL bitmap a given pixel appears in, whether to use said first algorithm or said second algorithm to transform a given pixel.

4. The one or more computer-readable storage media of claim 1, wherein said acts further comprise:
calculating an angle between a hue of said colorization target and a hue of a color that is representative of said first bitmap; and wherein said one or more transformations comprise:
rotating the hues of pixels in said first HSL bitmap through said angle.

5. The one or more computer-readable storage media of claim 1, wherein said one or more transformations comprise:
applying a gamma adjustment to the lightness of pixels in said first HSL bitmap.

6. The one or more computer-readable storage media of claim 5, wherein said one or more transformations further comprise:
applying said gamma adjustment to alpha values of pixels in said first HSL bitmap.

7. The one or more computer-readable storage media of claim 1, wherein said acts further comprise:
calculating a difference between a saturation of said colorization target and a saturation of a color that is representative of said first bitmap;
and wherein said one or more transformations further comprise:
applying a monotonic function to adjust to the saturation of pixels in said first HSL bitmap, wherein said linear adjustment scales said pixels based on the saturation of said colorization target.

8. The one or more computer-readable storage media of claim 1, wherein said acts further comprise:
smoothing said first bitmap by detecting hard boundaries along lines in said first bitmap and adjusting pixel values that do not cross said hard boundaries.

9. A system to colorize a first bitmap, the system comprising:
a processor;
a data remembrance component;
one or more components that are stored in said processor and that execute on said data remembrance component, the one or more components comprising:
a red-green-blue (RGB) to hue-saturation-lightness (HSL) converter, which converts said first bitmap to a first HSL bitmap;
one or more transformation components that transform said first HSL bitmap to a second HSL bitmap by transforming pixels in said first HSL bitmap based on a colorization target; and
an HSL to RGB converter that converts said second HSL bitmap to a second bitmap in RGB space; and
a display device on which said second bitmap is displayed.

10. The system of claim 9, further comprising:
an algorithm chooser that determines which of a plurality of algorithms to use to transform different sets of pixels in said first HSL bitmap, said algorithm chooser choosing a given algorithm based on wherein in said first HSL bitmap a given set of pixels is located.

11. The system of claim 9, wherein said first bitmap uses a first color to represent background portions of an image and uses a second color to represent highlight portions of said image, wherein said first color and said second color have opposing hues on a color wheel, and wherein the system further comprises:
an algorithm chooser that determines whether to transform a given pixel in said first HSL bitmap using a first algorithm or using a second algorithm that is different from said first algorithm, said algorithm chooser choosing said first algorithm or said second algorithm based on a comparison of said given pixel's hue with the hues of said first color and said second color.

12. The system of claim 9, wherein said first bitmap comprises an element of a user interface of an application, and wherein said display device displays said second bitmap as part of a colorized user interface, said colorization target having been selected by a user of said application.

13. The system of claim 9, wherein said one or more transformation components comprises a hue rotator that calculates an angle between a hue of said colorization target and a hue of a color that is representative of said first bitmap, and that rotates the hues of pixels in said first HSL bitmap through said angle.

14. The system of claim 9, wherein said one or more transformation components comprise:
a gamma adjuster that applying a gamma adjust to the lightness of pixels in said first HSL bitmap that applies said gamma adjustment to alpha values of pixels in said first HSL bitmap.

15. The system of claim 9, wherein said one or more transformation components comprise a saturation adjuster that calculates a difference between a saturation of said colorization target and a saturation of a color that is representative of said first bitmap, and that applies a linear adjustment to the saturation of pixels in said first HSL bitmap to scale said pixels based on the saturation of said colorization target.

16. The system of claim 15, wherein said saturation adjuster determines whether to scale said pixels toward full saturation or toward zero saturation based on whether said colorization target has a higher saturation or a lower saturation than the color that is representative of said first bitmap.

17. The system of claim 9, further comprising:
a smoother that detects hard boundaries along a line in said first bitmap and that smoothes said first bitmap by reducing variations among adjacent pixels in said line that do not cross said hard boundaries.

18. The system of claim 17, wherein said smoother determines that a hard boundary exists between adjacent pixels in said line whose values, in a given channel, differ from each other by more than one.

19. A method of colorizing an image, the method comprising:
using a processor to perform acts comprising:
receiving a first bitmap of said image, pixels in said first bitmap falling into sets comprising a first set and a second set, said first bitmap comprising an indication of which pixels fall into said first set and which pixels fall into said second set, said first set being different from said second set;
receiving a colorization target;
converting said first bitmap from red-green-blue (RGB) space to hue-saturation-lightness (HSL) space to create a first HSL bitmap;
transforming said first HSL bitmap to a second HSL bitmap by applying a first algorithm to pixels in said first set, and by applying a second algorithm to pixels in said second set, said second algorithm being different from said first algorithm;
converting said second HSL bitmap to a second bitmap in RGB space; and
displaying, to a user, said second HSL bitmap as part of a user interface of an application.

20. The method of claim 19, further comprising:
receiving said colorization target from said user through a color choice interface of said application,
and wherein said transforming comprises:
calculating an angle between a first hue of said colorization target and a second hue of a representative color of said first bitmap;
rotating colors of pixels in said first HSL bitmap through said angle;
performing a gamma adjustment on lightness and alpha values of pixels in said first HSL bitmap, said first algorithm having a different gamma adjustment from said second algorithm, the particular gamma adjustment that is performed on a given pixel being based on whether the given pixel is in said first set or said second set; and
linearly scaling saturation of pixels in said first HSL bitmap toward full saturation or toward zero saturation depending on whether saturation of said colorization target is higher or lower than saturation of said representative color.
